(19) United States
(12) Patent Application Publication
(10) Pub. No.: US 2006/0156469 A1
(43) Pub. Date: Jul. 20, 2006

(54) BPRS system (bed patient raise-sit system)

(76) Inventors: Arelyne Pacho Ramos, Deptford, NJ (US); Dale E. Suaan, Cherry Hill, NJ (US)

Correspondence Address: Arelyne Pacho Ramos, 123 Hamshire Drive, Deptford, NJ, 08096, US

(21) Appl. No.: 11/037,789

(22) Filed: Jan. 19, 2005

(51) Int. Cl. A61G 7/10

(52) U.S. Cl. 5/81.1 R

(57) ABSTRACT

The BPRS System is a medical device for raising or lowering the upper section of the body of an invalid patient, and for turning said patient to a sitting position on the side of the bed and back to the lying position. Said device has three members which correspond to the lower, middle and upper sections of the human body. The upper member is raised or lowered either manually or with the use of a means that can safely raise or lower the upper section of the body of the invalid patient weighing as much as 400 pounds.

### BACKGROUND OF THE INVENTION

1. Field of the Invention

The BPRS System is an invention which pertains to the medical field. It is intended to help solve the health problems encountered by care-givers when dealing with different kinds of patients in the hospitals and other health facilities. Care-givers, especially Nurses, can develop problems like carpal tunnel syndrome, back pain and pinched nerves when lifting or raising and laying down heavy patients. This device will facilitate the easy raising up and laying down of heavy patients and prevent the development of these common work-related ailments.

2. Description of Related Arts Including Information Disclosed Under 37 CFR 1.97 and 1.98.

In their researches, the Applicants have so far not found any medical device exactly the same as the BPRS System which can raise, lower down, or turn with ease and versatility heavy invalid patient to the side of the bed in a sitting position. There are existing medical devices, such as stretchers, which can lift and carry invalid patients from one place to another. And some beds can raise invalid patients up to a sitting position and lower them down. But these are usually stationary, bulky, heavy and with very limited functions. They do not have the versatility and practicality of the BPRS System. The BPRS System is a unique device that is not only portable, relatively light, but also versatile, practical and easy to use for raising, lowering down, or turning heavy invalid patients to the side of the bed in a sitting position without exerting too much effort.

### BRIEF SUMMARY OF THE INVENTION

The BPRS System is a medical equipment which can raise or lower the upper section of the body of an invalid patient and put the patient in a sitting position at the side of the bed. It looks like a stretcher or a cot which has 3 folding members, which correspond to the upper, middle and lower sections of the human body. This device uses a means for pulling up or lowering down the member which raises and lowers the upper section of the body of the patient. It can, thus, be operated either manually, with the use of a winch, or electrically, with the use of a linear actuator, or other means.

To operate the device, it should be positioned first, like a stretcher, at the back of the patient and strapped to his body. Then, the detachable parts of the device are attached before it is operated.

### BRIEF DESCRIPTION OF THE SEVERAL VIEWS OF THE DRAWINGS

FIG. 1 shows the device as laid flat on bed.

In FIG. 2, Option 1, the device uses an actuator to raise or lower the upper section of the human body.

In FIG. 3. Option 2, it uses a winch and wires as means for raising and lowering the upper section of the device.

FIG. 4 shows the device when the patient is in the sitting position at the side of the bed.

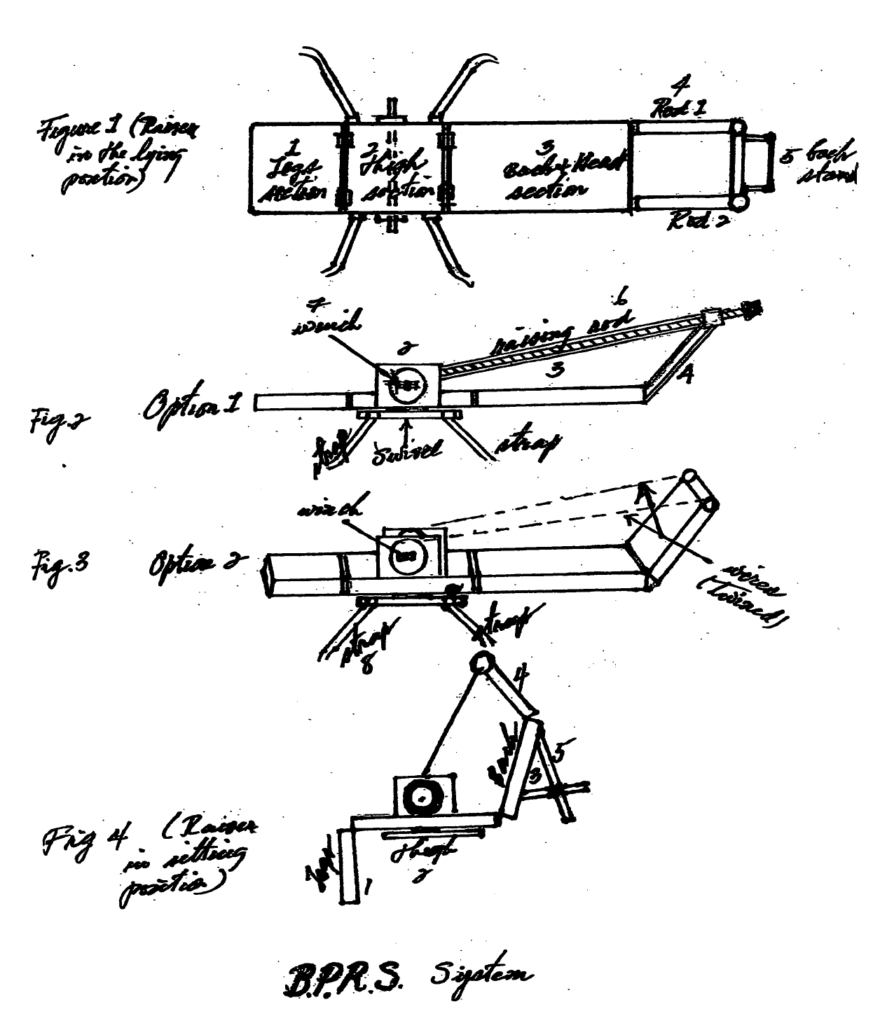

### DETAILED DESCRIPTION OF THE INVENTION

The BPRS System may be made of any sturdy material, like wood, metal, or hard plastic, as long as it is strong enough to raise and support as much as 400 pounds of weight. This device is about one foot wide and 6 feet long. It consists of 3 members which correspond to the upper, middle and lower sections of the human body. The members are joined to each other by sets of hinges, which make them foldable. The upper member measures about 2 feet long, stretching from the buttock to the head of the patient. The middle section measures one and a half feet long, stretching approximately from the buttock to the knees. The lower portion is about 2 feet long and it dangles down the side of the bed, when the patient is turned to the side of the bed in a sitting position. The bottom of the middle member of the BPRS System is attached to a swivel which is screwed to another sturdy material—measuring about 1 by 2 feet, and inch thick. This piece of sturdy material at the bottom of the swivel is strapped and secured properly to the sides of the bed before the actual operation of the BPRS System in order to keep it in place and prevent the device from moving while the patient is being raised, or lowered, or turned to the side of the bed. At the back of the BPRS System is a U-shaped rod, about the length of the upper member of the System, which supports and keeps the upper member securely in place, after the patient is raised to the sitting position. This U-shaped rod is manually retracted before the patient is again lowered to a lying position.

### ALTERNATIVE EMBODIMENT

While the preceding descriptions contain much specificity, these should not be construed as limitations on the scope of this invention, but rather as an exemplification of one preferred embodiment thereof. Many other variations and configurations are possible. Accordingly, the scope of this invention should be determined not only by the embodiments illustrated, examples and descriptions given, but also by the appended claims and their legal equivalents.

I claim:

1. A device for raising or lowering the upper section of the body of an invalid patient and for enabling said patient to be turned to the side of the bed in a sitting position.
1.a Said device having 3 folding members which correspond to the upper, middle and lower sections of the human body.
1. a.1 Each member of said device being made of rigid material and joined on ends by means that enable the upper and lower members of said device to move freely forward and backward.
1.b Said device being installed on top of the bed, and strapped to the back of the patient before it is being operated.
1.c Said device being operated either manually or with the use of a means that can raise or lower the upper member of said device.
1.d Said device having swivel at the bottom of its middle member for enabling the patient to be turned to the side of the bed in a sitting position and back to the lying position.
Whereby, the upper section of the body of said invalid patient is able to be easily raised or lowered, and the patient is able to be turned to the side of the bed in a sitting position and back to the lying position.
